(19) United States
(12) Patent Application Publication
(10) Pub. No.: US 2025/0344921 A1
(43) Pub. Date: Nov. 13, 2025

(54) AIRFLOW SPEED MONITORING SWITCH

(71) Applicant: Vacuum Technologies, LLC, Sheridan, WY (US)

(72) Inventors: James Jolly Harlan, Banner, WY (US); Justin Taylor Heaps, Ranchester, WY (US)

(21) Appl. No.: 19/203,003

(22) Filed: May 8, 2025

Related U.S. Application Data
(60) Provisional application No. 63/645,883, filed on May 11, 2024.

(51) Int. Cl. A47L 9/28; B60S 3/00; G01F 1/05

(52) U.S. Cl. CPC A47L 9/2821; A47L 9/2842; B60S 3/008; G01F 1/05

(57) ABSTRACT

An airflow monitoring switch system that includes: a switch having a switch arm that passes through an upper opening of a vacuum line where at least a portion of the switch arm extends through the upper opening of the vacuum line and into an interior of the vacuum line segment; a paddle having a vertical slot running from an uppermost point of the paddle and downwards towards a center point of the paddle; and a first paddle engaging bracket hingedly engaged to the switch arm and the paddle and a second paddle engaging bracket hingedly engaged to the switch arm on an opposite side of the first paddle engaging bracket. The vertical slot has a width that is greater than a width of the switch arm such that when the paddle is in the rotated position the switch arm is at least partially within the vertical slot.

### CROSS REFERENCE TO RELATED APPLICATION

This application claims priority to U.S. Provisional Ser. No. 63/645,883, filed on May 11, 2024, entitled “AIRFLOW SPEED MONITORING SWITCH”, the disclosure of which is incorporated by reference in its entirety.

### BACKGROUND

Car wash facilities often include vacuum systems that patrons of the car wash may use to vacuum inside of their vehicles. Individual canister vacuum systems located adjacent to the location where a vehicle may be vacuumed are sometimes employed. Also, systems are sometimes employed that use a central vacuum system providing vacuum forced air from a location remote from the vehicle location such as in a facility central building to the individual vehicle vacuuming bays. In such instances where the main vacuum supply motor of the facility is located in a central facility, the facility may sometimes employ a long main vacuum line to provide vacuum suction to numerous vacuuming locations at the facility. These systems generally employ a vacuum system with enough overall suction capacity to provide service to all of the vehicle vacuuming locations even though it is rare that all of the vehicle vacuuming locations are used simultaneously. The vacuum system may include one or more vacuum motors to create airflow within the system. Within the main vacuum line, a vacuum airflow speed monitoring sensor may be included to detect small or large changes in the airflow of the vacuum system. The airflow speed monitoring sensor can detect when an individual vacuum canister system is activated by the change in air speed alone.

During the operation of a car wash facility, the vacuum systems may go potentially large amounts of time while not being used. This is frequently the case during the winter months, because of the winter temperature and weather conditions make it less desirable for users to use the vacuum systems that are often located out in the outdoors. People do not generally want to get out of their cars or other vehicles into the cold to use the vacuums. Furthermore, they will need to keep their car or other vehicle partly open so that the vacuum hose can access the inside, which will leave the inside open to the colder temperatures and weather conditions of the outdoor environment as well.

It is preferable for a vacuum system to run continuously. This is especially true for a self-service vacuum system where the user of the system is a customer who does the vacuuming themselves with the vacuum hose provided by the car wash facility. Instead of having the vacuum motor repeatedly starting, increasing to full power, and stopping, the motor will run continuously, but at a lower power/speed, which uses less electricity. This also causes less strain on the vacuum motor, and increases its functional lifespan. Additionally, with air always moving, it is less likely for clods of ice, snow, and dirt to settle in the vacuum lines. Large compacted masses of debris can damage the overall vacuum systems and lower the efficiency of the of the system by blocking the airflow within the lines. So, in winter, when the vacuum sees less usage overall, the vacuum system is still turned on continuously, or at least during business hours. To balance the need to run the vacuum system continuously with the lower demand during winter, carwash facilities typically run their vacuum systems at a lower power until the vacuums are in use. When the vacuum is in use, a sensor detects the change in airflow and sends a signal to the motor to increase the power, and thereby suction, of the vacuum system. When the operation of the vacuum is concluded, the power and suction is dropped once again.

To determine when a vacuum system is being used, systems typically use a sensor that detects the presence of a vehicle in a vehicle vacuuming stall. A typical sensor is an inductance loop sensor located in the ground below the stall. Installation of an inductance loop sensor is expensive and time consuming. The installation process typically involves cutting a channel into the pavement, or other stall surface material, in order to make room for the inducting circuit. Thereafter the pavement is repaired. Alternatively, the vacuum stall may have video cameras, infrared sensors, microwave sensors, or ultrasonic sensors to detect the presence of a vehicle in the location where a user may use the vacuum system. Most external sensors, like the inductance loop sensor will be expensive and time consuming to install and be subject to weather conditions that could damage the equipment.

A typical vacuum sensor included a paddle that extends into the main vacuum line. The paddle is pushed against by the moving air, which flexes it and produces a measurable strain or pressure on the paddle. A sensor attached to the paddle detects the strain/pressure, and the data is used to determine the airflow within the vacuum line. The paddle is typically an elongated, generally rectangular elongated member, with a flat face directed against the flow of air within the vacuum line. The paddle may not be very large compared to the space within the vacuum line, and as such, it may not catch much air and give inaccurate readings. Additionally, the airflow may be very strong, and the paddle may break or warp. Debris that gets into the vacuum line may strike the paddle and break/warp it as well. If the paddle or other parts of the switch break, pieces could be sucked into the vacuum motor and damage it.

### SUMMARY

An aspect of the present disclosure is generally directed toward an airflow monitoring switch system that is retrofitted into an existing vacuum line of a vehicle treatment facility and that monitors an airflow within the existing vacuum line. It includes a vacuum line segment with a first open end, a second open end, and an upper opening located between the first open end and the second open end. The vacuum line segment replaces a portion of the existing vacuum line, and is substantially the same size/shape. The airflow monitoring switch system further includes a switch having a switch arm that passes through the upper opening into an interior of the vacuum line segment. A paddle is typically hingedly connected to the switch arm and the paddle typically has a first surface and a second surface opposite to the first surface. The paddle has a rest position where the first surface and the second surface are aligned with the switch arm and a rotated position where the first surface and the second surface form a non-zero degree angle with the switch arm, and wherein the paddle is biased towards the rest position and remains in the rest position unless acted on by an external force. The first surface and the second surface of the paddle are perpendicular to a direction of airflow within the existing vacuum line.

Another aspect of the present disclosure is generally directed toward an airflow monitoring switch system that is retrofitted into an existing vacuum line of a vehicle treatment facility and that monitors the airflow within the existing vacuum line. The system has a switch having a switch arm, a flat paddle having a first surface, a second surface opposite to the first surface, and a vertical slot running from the uppermost point of the flat paddle and downwards towards a center point of the flat paddle, and an arm connection portion that is engaged to the switch arm. Additionally, there is a first paddle connection portion and a second paddle connection portion that are both engaged to the paddle on either side of the vertical slot. Both the first paddle connection portion and the second paddle connection portion are hingedly engaged to the arm connection portion so that the paddle swings relative to the switch arm. In this way, the paddle has rest position where the first surface and the second surface are aligned with the switch arm and a rotated position where the paddle first surface and the second surface form a non-zero degree angle with the switch arm. A breakaway position, where the paddle is aligned with the airflow is possible, and enables the paddle to survive excessive airflows without breaking. The vertical slot has a width that is greater than a width of the arm connection portion. The arm connection portion is proximate to the vertical slot such that when the paddle is in the rotated position the arm connection portion is at least partially within the vertical slot.

Another aspect of the present disclosure is generally directed toward an airflow monitoring switch system that is retrofitted into an existing vacuum line of a vehicle treatment facility and that monitors the airflow within the existing vacuum line. The system has a switch having a switch arm, a flat paddle having a first surface, a second surface opposite to the first surface, and a vertical slot running from the uppermost point of the flat paddle and downwards towards a center point of the flat paddle, and an arm connection portion that is engaged to the switch arm. The airflow monitoring switch system is part of a vacuum line segment that is inserted into the main vacuum line at a point between the cyclonic separator and the vacuum motor. The vacuum line segment has a first open end, a second open end, and an upper opening located between the first open end and the second open end. Additionally, there is a first paddle connection portion and a second paddle connection portion that are both engaged to the paddle on either side of the vertical slot. Both the first paddle connection portion and the second paddle connection portion are hingedly engaged to the arm connection portion so that the paddle swings relative to the switch arm. In this way, the paddle has rest position where the first surface and the second surface are aligned with the switch arm and a rotated position where the paddle first surface and the second surface form a non-zero degree angle with the switch arm. A breakaway position, where the paddle is aligned with the airflow is possible, and enables the paddle to survive excessive airflows without breaking. The vertical slot has a width that is greater than a width of the arm connection portion. The arm connection portion is proximate to the vertical slot such that when the paddle is in the rotated position the arm connection portion is at least partially within the vertical slot.

Yet another aspect of the present disclosure is generally directed toward a method of adjusting the airflow within a main vacuum line that is part of a vehicle treatment facility. The vehicle treatment facility has a vacuum motor and at least one vacuum stall. A main vacuum line provides suction from the vacuum motor to the vacuum stall. The method makes use of an airflow monitoring switch system. The airflow monitoring switch system has a switch with a switch arm, a flat paddle with a first surface, a second surface opposite to the first surface, and a vertical slot running from the uppermost point of the flat paddle and downwards towards a center point of the flat paddle, and an arm connection portion that is engaged to the switch arm. The first paddle connection portion and the second paddle connection portion are engaged to the paddle on either side of the vertical slot and are both hingedly engaged to the arm connection portion. The paddle swings relative to the switch arm. The paddle has a rest position where the first surface and the second surface are aligned with the switch arm and a rotated position where the paddle first surface and the second surface form a non-zero degree angle with the switch arm. The vertical slot has a width that is greater than a width of the arm connection portion. The arm connection portion is proximate to the vertical slot such that when the paddle is in the rotated position the arm connection portion is at least partially within the vertical slot. The method includes the steps of: activating at least one vacuum operably connected to the main vacuum line located in a vacuum stall, where the vacuum has a required airflow to meet a predetermined amount of suction, and where activating the vacuum causes a change in the airflow within the main vacuum line so that a new airflow is higher than the initial airflow; activating the switch by increasing a pressure on the paddle of the switch to a predetermined pressure due to the change in airflow, and where the switch will not be activated if the pressure on the paddle is not at the predetermined pressure; sensing the pressure change on the switch and determining the change in airflow from the pressure change; sending a signal to a vacuum motor to tell it to change the airflow accordingly; increasing the airflow within the main vacuum line with the vacuum motor to set the airflow to an operating airflow, where the operating airflow is greater than the initial airflow plus the change in airflow, and the operating airflow is at an amount of at least the required airflow; deactivating the at least one vacuum, which creates a decrease in airflow within the main vacuum line so that a second new airflow is lower than the operating airflow; deactivating the switch by decreasing the pressure on the paddle by a second predetermined pressure and where the switch will not deactivate if the pressure is above the second predetermined pressure; sending a signal to a vacuum motor to tell it to decrease the airflow; and decreasing the airflow within the main vacuum line with the vacuum motor to set the airflow to the initial airflow.

Another aspect of the present disclosure is generally directed toward a method of adjusting an airflow within a main vacuum line that is part of a vehicle treatment facility having a vacuum motor and at least one vacuum stall and wherein the main vacuum line provides suction from the vacuum motor to a vacuum hose associated with at least one vacuum stall and includes the steps of: a user beginning to use the vacuum hose associated with the at least one vacuum stall thereby changing rate of airflow passing the airflow monitoring switch defining a change in the rate of airflow; the change in the rate of airflow thereby activating the switch by increasing a pressure on the paddle of the switch due to the change in the rate of airflow, and wherein the switch is activated if the pressure on the paddle is at or greater than a predetermined pressure on the paddle; sending a signal to the vacuum motor if the pressure on the paddle is at or greater than the predetermined pressure on the paddle; increasing the airflow within the main vacuum line using the vacuum motor to set an operating airflow, wherein the operating airflow is greater than an initial airflow plus the change in airflow, and the operating airflow is at an amount of at least a required airflow sufficient to provide vacuum power to all users of the vehicle treatment facility; deactivating use of the vacuum hose associated with the at least one vacuum stall thereby decreasing airflow within the main vacuum line so that a second new airflow that is lower than the operating airflow results; deactivating the switch due to the second new airflow decreasing the pressure on the paddle to a level below a second predetermined pressure and wherein the switch will not deactivate if the pressure on the paddle is above the second predetermined pressure; sending a signal to the vacuum motor once the switch is deactivated to decrease the airflow provided by the vacuum motor; and decreasing the airflow within the main vacuum line provided by the vacuum motor.

Yet another aspect of the present disclosure is generally directed toward an airflow monitoring switch system that may be retrofitted into a vacuum line of a vehicle treatment facility and that monitors an airflow within the vacuum line. It includes a vacuum line segment having a first open end, a second open end, and an upper opening located between the first open end and the second open end. The vacuum line segment replaces a portion of the vacuum line. The airflow monitoring switch system includes a switch at least partially positioned above the opening located between the first open end and the second open end that includes a switch arm that passes through the upper opening into an interior of the vacuum line segment. The airflow monitoring switch system also includes a paddle hingedly connected to the switch arm, the paddle having a first surface and a second surface opposite to the first surface. The paddle is planar and is sized to have the same shape as an interior shape of the vacuum line segment that is defined by an interior surface of the vacuum line segment. The paddle fills/blocks at least about 80% of the airflow through the vacuum line segment when the paddle is in a rest position defined as a position where the first surface and the second surface are aligned with the switch arm. The paddle also has a rotated position wherein the first surface and the second surface form a non-zero-degree angle with the switch arm. The first surface and the second surface of the paddle are perpendicular to a direction of airflow within the vacuum line.

Another aspect of the present disclosure is generally directed toward an airflow monitoring switch system. It includes a switch having a switch arm that passes through an upper opening of a vacuum line. At least a portion of the switch arm extends through the upper opening of the vacuum line and into an interior of the vacuum line. There is a paddle having a first surface, a second surface opposite to the first surface, and a vertical slot running from an uppermost point of the paddle and downwards towards a center point of the paddle. The paddle is engaged to the switch arm by a first paddle engaging bracket hingedly engaged to the switch arm and the paddle and a second paddle engaging bracket hingedly engaged to the switch arm on an opposite side of the first paddle engaging bracket. The paddle swings relative to the switch arm in response to a force and has a rest position where the first surface and the second surface are aligned with the switch arm and a rotated position where the first surface and the second surface form a non-zero-degree angle with the switch arm. The vertical slot has a width that is greater than a width of the switch arm and that when the paddle is in the rotated position the switch arm is at least partially within the vertical slot. The paddle is suspended within the vacuum line.

These and other aspects, objects, and features of the present disclosure and claimed invention will be understood and appreciated by those skilled in the art upon studying the following specification, claims, and appended drawings.

### BRIEF DESCRIPTION OF THE DRAWINGS

In the drawings:

FIG. 1A is perspective view of an exemplary car wash facility and its related vacuum system(s) and shows the building and vacuum systems where the main vacuum line is underground and not shown while nevertheless shared across each of the vacuum stalls/vehicle vacuuming locations.

FIG. 1B is a partial perspective view of the vacuum system(s) and stalls of an exemplary vacuum system of a car wash facility showing an aspect of the disclosure where the main vacuum line supplying vacuum to each of the individual stalls is above ground.

FIG. 2 is a front perspective view of a prior art paddle sensor for detecting the airflow within a vacuum line.

FIG. 3 is a view of a prior art paddle sensor for detecting the airflow within a vacuum line while the paddle sensor is disposed within the vacuum line and the vacuum line further includes airflow directing wings.

FIG. 4 shows the outside surface of the airflow monitoring switch system according to an aspect of the present disclosure.

FIG. 5 shows the airflow monitoring switch system according to an aspect of the present disclosure with the vacuum line segment transparent so that the airflow monitoring switch and the filter may be seen.

FIG. 6 is a lower perspective view of an airflow monitoring switch according to an aspect of the present disclosure.

FIG. 7 is a front view of the airflow monitoring switch system according to an aspect of the present disclosure.

FIG. 8 is a rear view of the airflow monitoring switch system according to an aspect of the present disclosure.

FIG. 9 is a cross sectional view of the airflow monitoring switch system taken along line VIII in FIG. 5 cutting along the center of the cylindrical airflow pathway according to an aspect of the present disclosure.

FIG. 10 is a side view of the airflow monitoring switch while the paddle is in a relaxed, down position according to an aspect of the present disclosure.

FIG. 11 is a side view of the airflow monitoring switch while the paddle is in a rotated position due to an increased airflow within the vacuum line segment according to an aspect of the present disclosure.

FIG. 12 is a side view of the airflow monitoring switch while the paddle is in a breakaway position wherein the paddle rotates to a horizontal, or nearly horizontal, position in order to prevent damage from excessive airflow within the vacuum line according to an aspect of the present disclosure.

FIG. 13 is a front perspective view of the filter and the attached L-shaped brackets according to an aspect of the present disclosure.

FIG. 14 is a diagram showing the logic used by the airflow monitoring switch system and the PID controller to track the status of the switch and control whether the vacuum motor is in sleep mode or an active mode.

FIG. 15 is a diagram showing the airflow through a system. The air typically moves from a debris separator, which may be a cyclonic debris separator, to the airflow monitoring switch, and finally to the vacuum motor, which may be one or more vacuum motors held within a building at the overall vehicle treatment facility.

### DETAILED DESCRIPTION

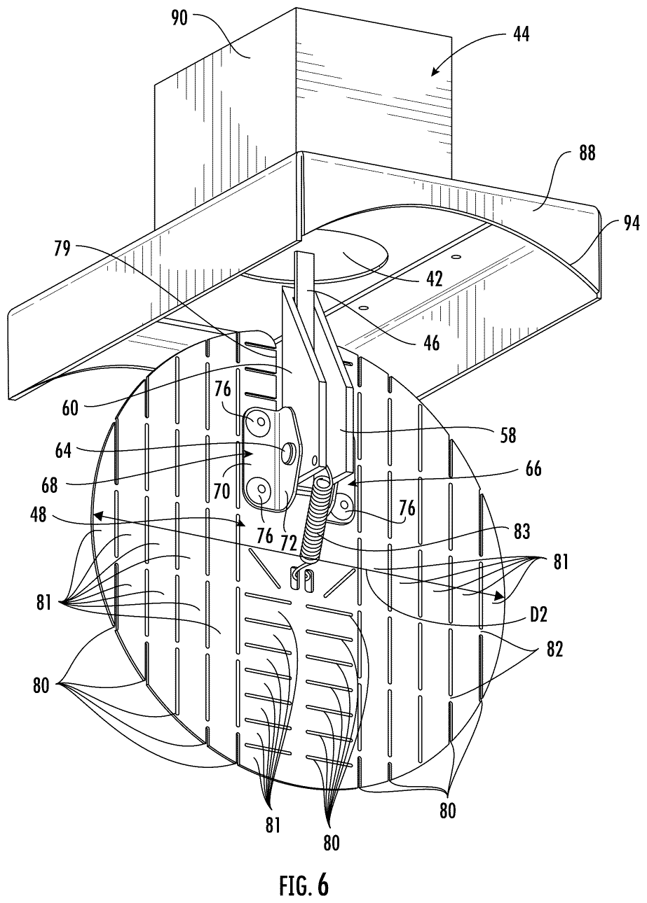

For purposes of description herein, the terms “upper,” “lower,” “right,” “left,” “rear,” “front,” “vertical,” “horizontal,” and derivatives thereof shall relate to the invention as oriented in FIG. 6. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

The term “about” in the context of the present application means a range of values inclusive of the specified value that a person skilled in the art would reasonably consider to be comparable to the specified value. In certain aspects of the present disclosure, “about” means within a standard deviation using measurements generally accepted in the art. In other aspects of the present disclosure, “about” will mean the specified value but ranging up to +10% of the specified value.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure and claimed invention, and further it is to be understood that such concepts are intended to be covered by the following claims unless these claims by their language expressly state otherwise.

It is to be understood that the disclosed innovations may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Where a range of values is provided, it is understood that each intervening value, to the tenth of the unit of the lower limit unless the context clearly dictates otherwise, between the upper and lower limit of that range, and any other stated or intervening value in that stated range, is encompassed within the scope of the present disclosure. The upper and lower limits of these smaller ranges may independently be included in the smaller ranges, and are also encompassed within the scope of the present disclosure, subject to any specifically excluded limit in the stated range. Where the stated range includes one or both of the limits, ranges excluding either or both of those included limits are also included in the scope of the present disclosure. All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, 10) contained within the range. In this specification and the appended claims, the singular forms “a,” “an” and “the” include plural reference unless the context clearly dictates otherwise. All combinations of method steps or process steps as used herein can be performed in any order, unless otherwise specified or clearly implied to the contrary by the context in which the referenced combination is made.

To the extent that the terms “includes” or “including” or “have” or “having” are used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A” or “B” or both “A” and “B”. When the Applicant intends to indicate “only A or B but not both” then the term “only A or B but not both” or similar structure will be employed. Thus, use of the term “or” herein is the inclusive, and not the exclusive use. Also, to the extent that the terms “in” or “into” are used in the specification or the claims, it is intended to additionally mean “on” or “onto.” In this specification and the appended claims, the singular forms “a,” “an” and “the” include plural reference unless the context clearly dictates otherwise.

For purposes of this disclosure, airflow may be defined as the amount of air passing through an area over a unit of time. The amount of air may be defined as a volume of air or a mass of air. The units of time may be a second, a minute, an hour, or other units of time as desired. Generally, airflow will be given in, but not limited to, cubic feet per minute in the present disclosure.

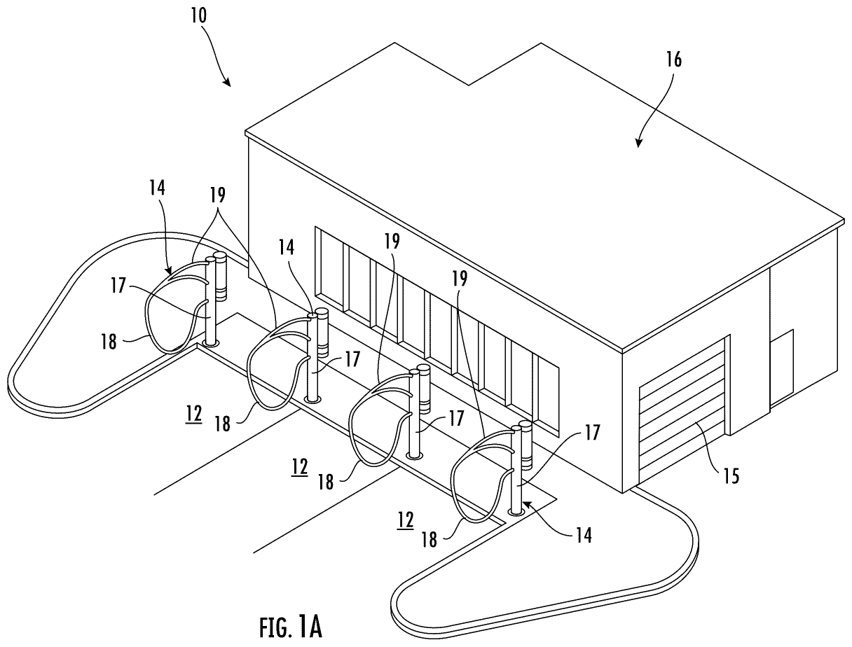

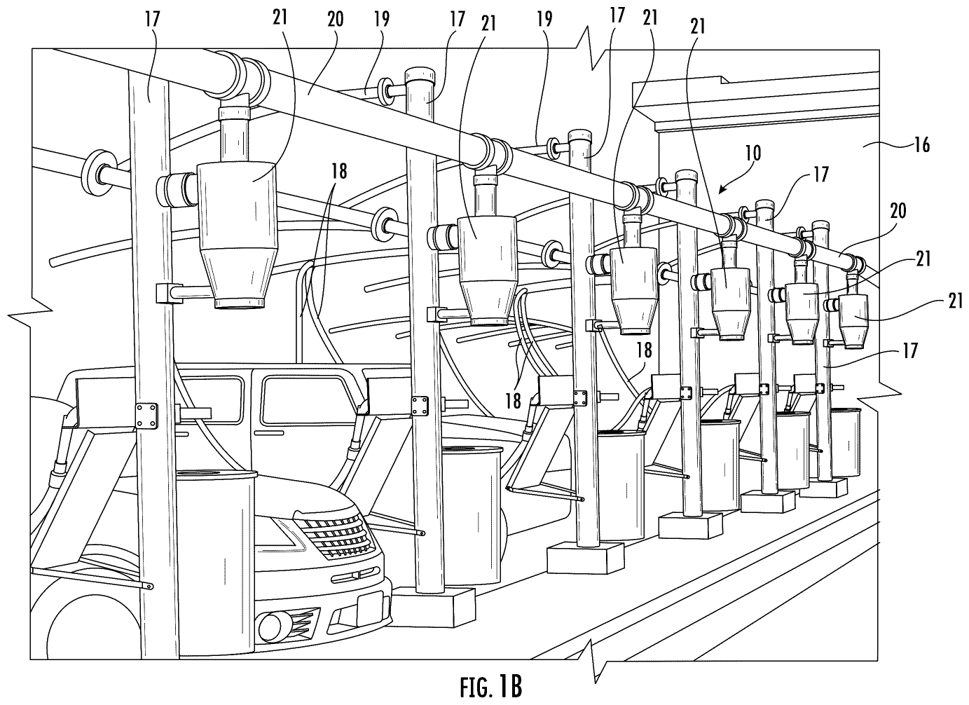

FIG. 1A generally displays an overall vehicle treatment facility 10 in which a vacuum motor assembly 22 of the present disclosure may be used to provide vacuum force/power to a plurality of locations simultaneously or one location as well if only one vacuum stall 12 is in use. The vehicle treatment facility may include a door 15 that opens when a vehicle enters the vehicle washing portion of the vehicle treatment facility. The vacuum motor assembly 22 of the present disclosure is typically positioned inside a portion of the main building 16 at the vehicle treatment facility and is typically positioned in a portion of the main building or a separate enclosure/building from the vehicle treatment facility such that it is separated from the washing portion of the facility but still enclosed and protected in order to protect it from weather and other environmental factors. The vacuum motor assemblies of the present disclosure provide vacuum force/power for each of at least one, but typically a plurality of, vacuum subsystem 14 that are each associated with at least one vacuum stall 12. A user of the vehicle treatment facility is able to park their vehicle in the vacuum stall 12, and use the vacuum subsystem 14 to clean the inside of their vehicle.

The vacuum subsystems 14 are each interconnected to a main vacuum line 20 that is operable engaged with the vacuum motor assembly 22. The vacuum subsystems 14 each typically include a vertical support pole 17, an arch 19 that extends from the top of the vertical support pole 17 above the vacuum stall 12, and a hose 18 that hangs down from the arch 19 such that a user can manipulate the hose 18 without it dragging across the ground. Each of the systems may include a cyclonic separator 21 positioned between the hose and the main vacuum line. Each vacuum system's hose 18 attaches to a main vacuum line 20 either directly or indirectly through a cyclonic separator 21 (See FIG. 1B), which is in turn, attached to a vacuum motor assembly 22, which provides vacuum power using a motor 26. In FIG. 1A, the vacuum hoses 18 and the main vacuum line 20 run underground, and are therefore not visible in the figure. The main vacuum line 20 can be located underground or above ground. In FIG. 1B, the main vacuum line 20 is positioned above the ground. Due to the amount of airflow that can be produced by the vacuum motor assembly 22, only a single unit needs to be used to run every vacuum system at the facility without the use of additional vacuum motor assemblies. The vacuum motor assembly 22 will typically be sized to provide the necessary vacuum forces to effectively provide service to every stall of the overall vehicle treatment facility 10 even if each and every hose 18 is in use simultaneously. Alternatively, there may be multiple vacuum motor assemblies providing suction to each hose 18.

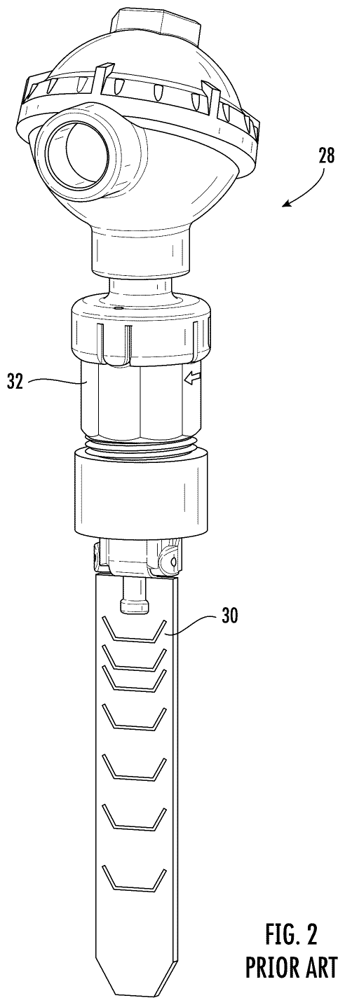

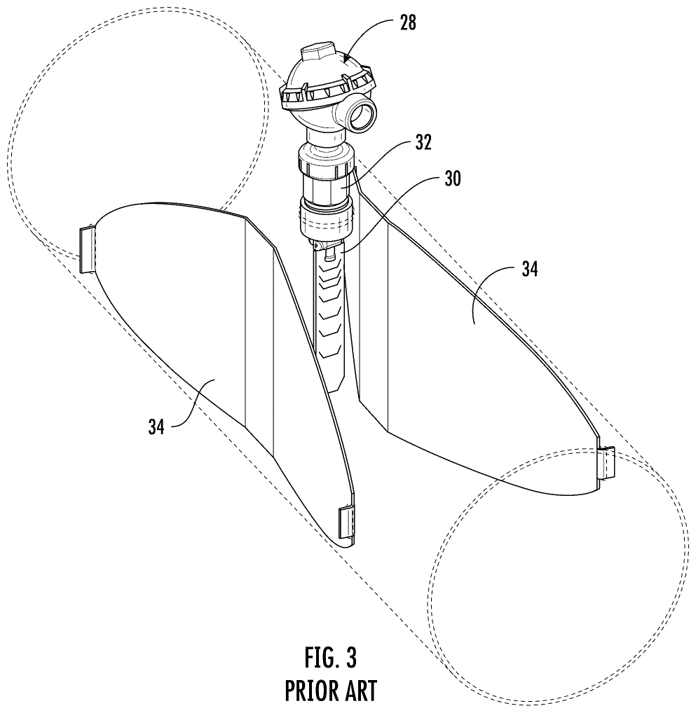

As shown in FIGS. 2-3, a prior art sensor 28 includes an elongated, flat member 30 that extends into vacuum line. The elongated, flat member is typically rectangular and may have a rounded end or an end with chamfered corners. The elongated flat member 30 is engaged with a sensor portion that extends through the main vacuum line to the exterior of the main vacuum line. Here there may be a wired or wireless connection with the vacuum motor assembly, so that the sensor can send a signal to the vacuum motor when a certain pressure on the elongated flat member is detected. As air passes through the main vacuum line, it pushes against the elongated, flat member, similar to a sail of a boat. This causes the elongated, flat member to bend about its position attached to the sensor portion 32. The sensor portion 32 is a switch incorporating the elongated, flat member, and detects a change in pressure acting on the switch. From there, the pressure can be used to calculate the airflow present within the main vacuum line. Changes in the airflow are also picked up by the sensor portion by the change of pressure exerted on the elongated, flat member. The elongated, flat member has portions designed to be cut off in order to calibrate the airflow detection to a desired airflow level.

There are a number of issues with this type of system. For one, the elongated, flat member barely covers any of the cross-sectional area of the main vacuum line. It may not be able to accurately read the airflow if the air easily passes by it without disrupting the member's position. To remedy this, the main vacuum line may include one or more airflow directing wings 34 positioned opposite from one another around the elongated, flat member. The airflow directing wings 34 may be form fitted to the inside of the main vacuum line, and artificially decrease the cross-sectional size of the main vacuum line. The airflow directing wings 34 are generally triangular when viewed from above in order to drive the air directly to the elongated, flat member. An installer will need multiple wings in the main vacuum line, which increases the cost of the device. Additionally, the airflow directing wings can disrupt the airflow negatively and direct debris directly to the elongated flat member alongside the air. The member may also bend too much or break entirely, requiring a user to replace the components.

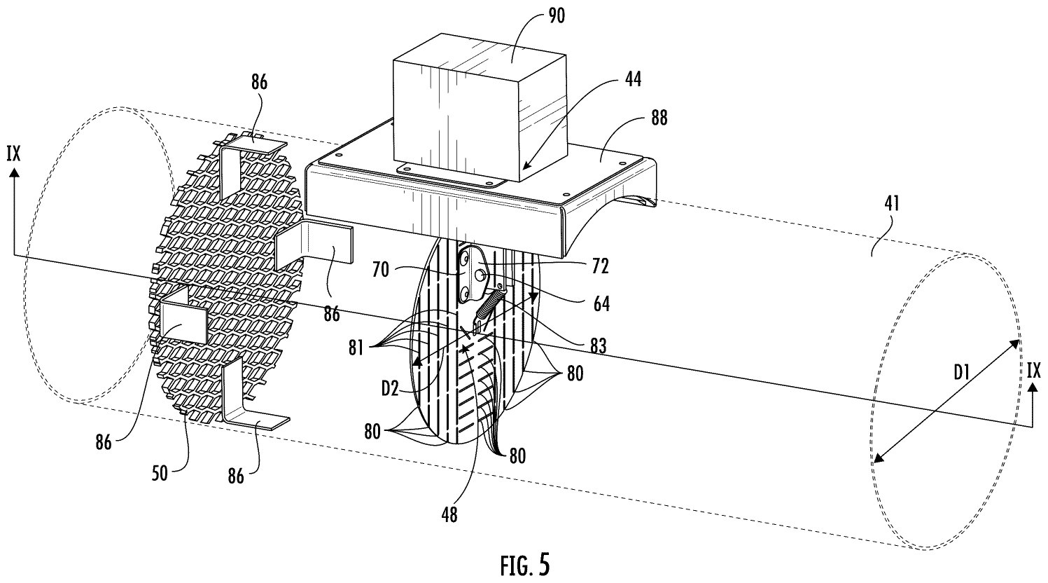

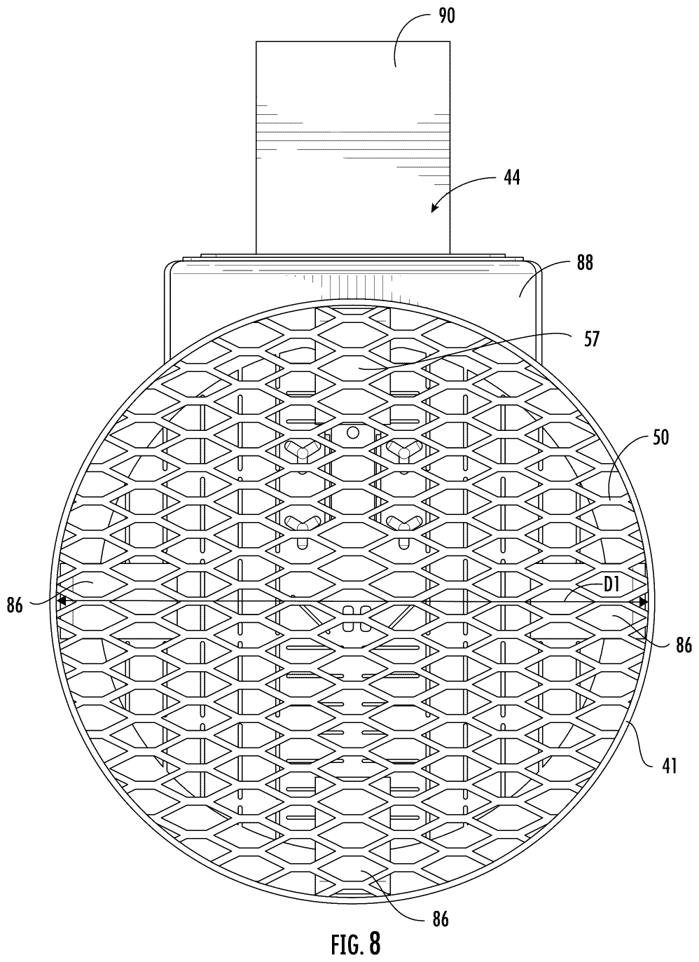

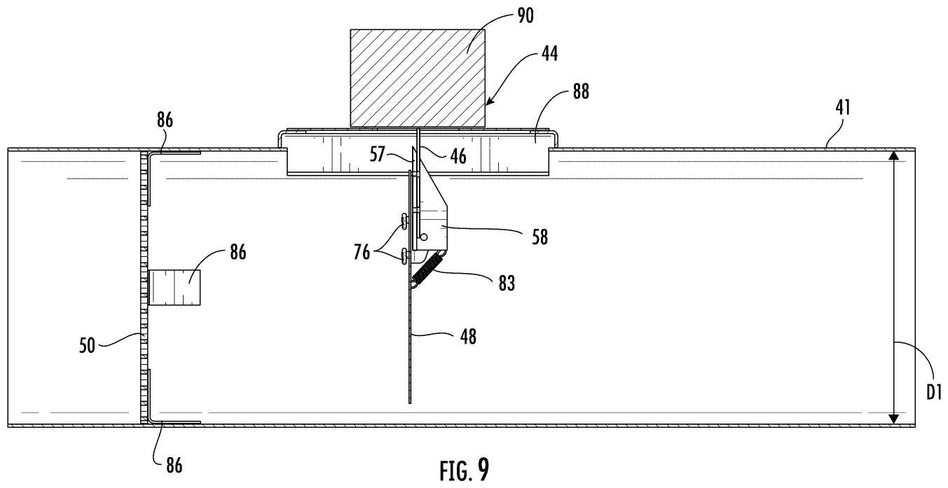

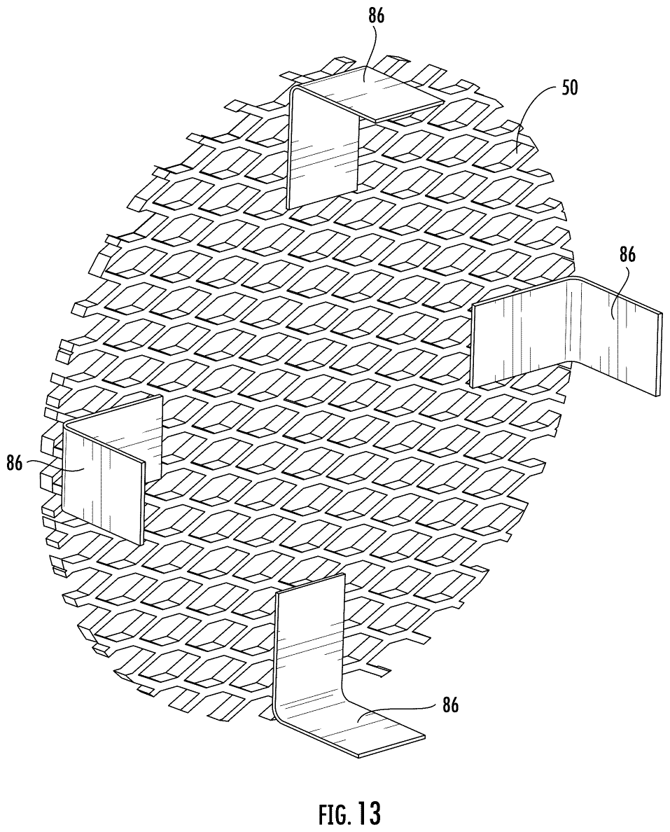

Shown in FIGS. 3-13, the airflow monitoring switch system 40 of the present disclosure is able to be retrofitted into an existing vacuum system by modifying a section of the main vacuum line by adding a new vacuum line portion 41. While the airflow monitoring switch is typically used in connection with vacuum systems at a vehicle washing and treatment facility, the switch could conceivably be used in any mechanical system where measurement of airflow is desirable or needed. For example, the systems of the present disclosure could be used in a heating or cooling system. The airflow monitoring switch system typically includes a sensor portion 44 having an airflow monitoring switch 42, a switch arm 46 operably engaged to the sensor portion, and a paddle 48 that is hingedly engaged to the switch arm. The airflow monitoring switch system may further include a filter 50, which is located within the main vacuum line 20 or in the vacuum line portion 41, but downstream in relation to the airflow monitoring switch 42. The filter is affixed to the interior of the new vacuum line portion 41 to create a sturdy barrier to prevent large damaging fragments from traversing past the filter. The airflow monitoring switch system 40 also typically is not used in conjunction with and the overall system is typically free of any use of airflow directing wings affixed to the internal surface of the vacuum line, in particular any such wings proximate an airflow monitoring switch of the present disclosure.

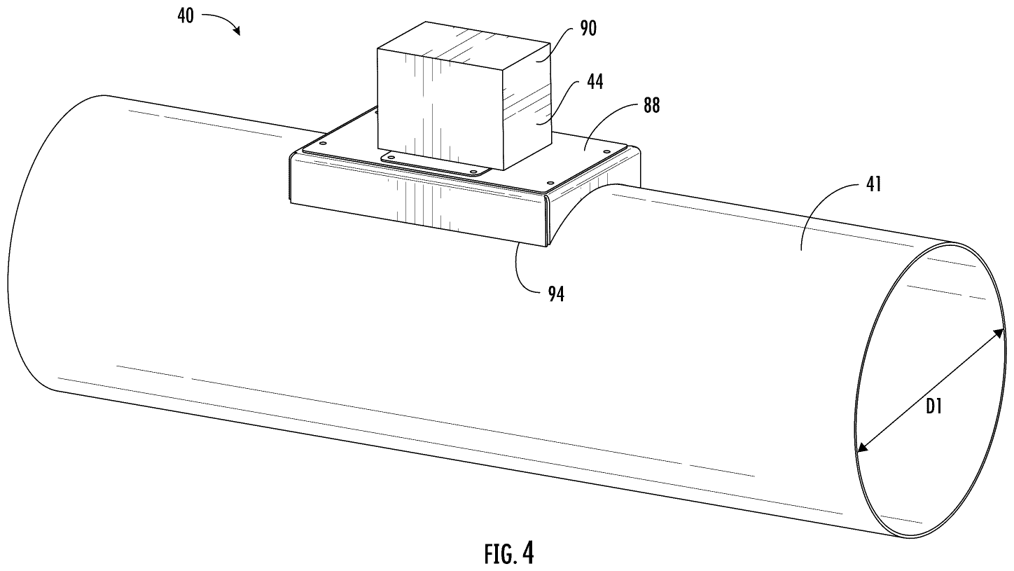

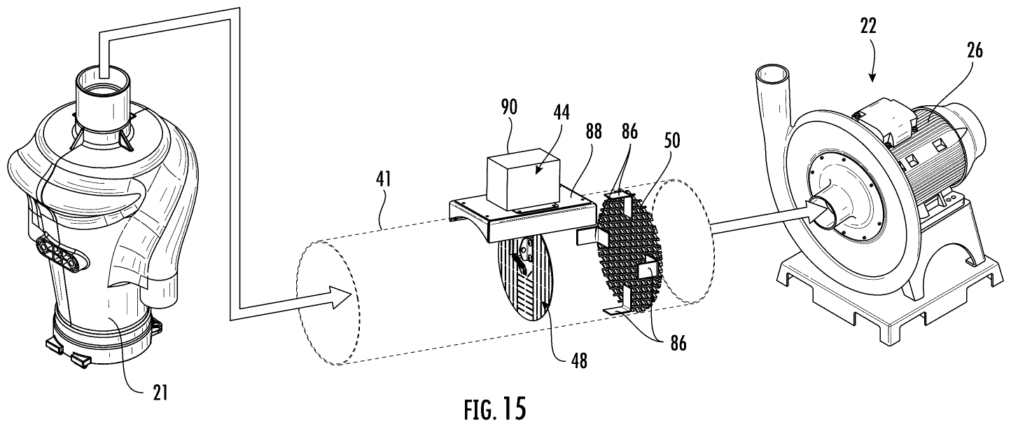

In retrofitting the main vacuum line 20 (see FIG. 1B) to include the airflow monitoring switch system, a length of pipe, or vacuum line portion 41 that contains the filter and the airflow monitoring switch of the present disclosure is inserted into the main vacuum line. The vacuum line portion 41 typically has a virtually identical or the same diameter or just slightly smaller diameter (within from 95 to 99% of the diameter of the main vacuum line) as the main vacuum line so that it can be easily attached to the main vacuum line without disrupting the air flow. The outer surface of the vacuum line portion is best seen in FIG. 4. The air speed in the vacuum line portion 41 will be different compared to the air speed in the rest of main vacuum line if the diameters are different. This may produce inaccurate readings for the airflow of the main vacuum line overall, since the sensor is contained only to the vacuum line portion 41. The vacuum line portion 41 may be made of the same or similar materials as the main vacuum line and can be metal or plastic. In an aspect of the present disclosure, the main vacuum line and the vacuum line portion 41 are made of polyvinylchloride (PVC) pipe. In another embodiment, the main vacuum line and the vacuum line portion 41 are made of a metal such as aluminum. The vacuum line portion 41 may be attached to the main vacuum line by screw on nipple connectors, a welded connection, or PVC fittings, or another acceptable pipe connecting device. The connection between the main vacuum line and the vacuum line portion 41 is at least substantially air tight or totally tight and typically at least secure enough as to prevent air from leaking and causing the airflow to decrease substantially to the point it would affect the power of the overall system. The airflow monitoring switch system is positioned in the main vacuum line between the cyclonic separator 21 and the vacuum motor 26 as seen in FIG. 15 so that air must pass through the airflow monitoring switch before it reaches the vacuum motor. In a potential embodiment, the airflow monitoring switch system 40 is integrated directly into a cyclonic separator instead of the main vacuum line.

The airflow monitoring switch system 40 allows overall vehicle treatment facility to change the amount of suction from a vacuum system so that the vacuum system can operate in a lower power, or sleep mode, as well as having a normal operational power level corresponding to the number of vacuum stalls currently in use at the overall vehicle treatment facility. This is especially useful during times with few customers using the vacuums. When a vacuum stall is activated, possibly by a customer of the overall vehicle treatment facility pulling a vacuum hose nozzle out of a sheath, the airflow within the main vacuum line is increased by a small amount. This small increase in airflow pushes on the paddle 48, which in turn causes the switch arm 46 and the airflow monitoring switch 42 to move. This movement is seen as a change of pressure exerted on the airflow monitoring switch 42. A proportional-integral-derivative (PID) controller is able to determine from the pressure increase whether a vacuum stall, or even multiple vacuum stalls are occupied. A signal is sent to the vacuum motor to increase the suction in the main vacuum line 20 so that each of the vacuum stalls in use have adequate suction power.

The switch arm 46 typically is an elongated supporting member and is attached to connection portion 54. The switch arm 46 has a straight, generally rectangular shape, and extends into the main vacuum line from the sensor portion 44. The angled connection portion comprises a rectangular base with two longer sides and two shorter sides, and a right side flange 58 and a left side flange 60 extending away from the two longer sides of the rectangular base. The right side flange 58 and the left side flange 60 each typically have a first straight edge that is perpendicular to, and extending from, the rectangular base, a second straight edge that is parallel to the rectangular base and perpendicular with the first straight edge, and an angled edge, which extends from the rectangular base to the second straight edge. Thus, both of the flanges have the same trapezoidal shape. Together with the rectangular base, the right side flange and the left side flange form an interior slot into which the elongated support member is disposed. Both of the flanges have a flange hinge pin through hole punched through the flange and aligned with one another so that a hinge pin 64 can pass straight through both of the through holes on each of the flanges. The elongated support member is engaged to the rectangular base 57, but may also be connected directly to either of the flanges. The connection is most commonly made with a fastener such as a screw or bolt, but may also be welded or attached with adhesives.

The right and left side flanges may be different shapes or sizes. The flanges are present to provide a fixation point for the hinge pin to connect indirectly to the switch arm, and so they need to extend outwards far enough to accommodate the width of the hinge pin while simultaneously being thick enough to prevent breaking under the strain. In a potential embodiment, the right and left side flanges are triangular.

The paddle connection portion 54 includes a right side paddle connecting portion 66 and a left side paddle connecting portion 68. Both of the right side paddle connecting portion 66 and the left side paddle connecting portion 68 have a paddle connecting base 70 and a hinge engaging flange 72 that extends perpendicularly from an innermost side of the paddle connecting base. The paddle connecting base 70 is typically flat/planar with a paddle engaging surface that is pressed flat against the paddle and an opposite outer surface proximate to the hinge engaging flange. The paddle engaging base also has a plurality of through holes through which an adjustable fastener 76 or adjustable fasteners can pass through. The right side and left side paddle connecting portions are positioned against the paddle such that the plurality of through holes align with a plurality of paddle through holes. The fasteners are inserted through the plurality of through holes and the plurality of paddle through holes. The hinge engaging flange may have a pointed center. A hinge through hole cuts through the hinge engaging flange above or below its midpoint, typically proximate to the pointed portion if it has a pointed portion. A hinge pin 64 extends between the hinge engaging flanges and passes through hinge through holes in the paddle connection portion 54. The hinge pin may have a frictional fit, or it may spin freely without much resistance.

The paddle typically has a flat, generally circular shape in order to conform with the shape of the inside of the main vacuum line and fit within the internal diameter of the main vacuum line. The paddle may be shaped differently if the main vacuum line 20 is not a circular pipe but will typically cover at least about 80%, more typically about 90% to about 100%, and more typically from about 98 to about 100% of the cross-sectional area of the internal diameter of the main vacuum line. The paddle 48 has a diameter (D2) that is less than, but typically close to, the diameter (D1) of the inside of the main vacuum line. The diameter D2 is typically about 7.5 inches to about 8.5 inches and the diameter D1 is typically about 8 inches to about 9 inches. The main vacuum line is most typically standardized at about 8 inches, so the diameter D2 is preferably smaller than 8 inches. The paddle should cover the majority of a cross sectional area of the main vacuum line 20, more typically at least about 80% of the cross-sectional area. The thickness of the paddle 48 is about 0.05 inches, but is typically smaller than 0.05 inches, from about 0.01 to about 0.048 inches. A series of perforated lines 80 typically cross the surface of the paddle. The perforations allow a user to snap off portions of the paddle in order to calibrate it to respond to particular airflow measurements. The perforated lines 80 may also have different orientations and lengths. The paddle also typically has a vertical slot 79 starting from its uppermost point and extending downwards through the paddle to its center. The slot is wide enough to accommodate the arm connection portion of the switch arm. The right and left side connecting portions of the switch arm are located on either side of the vertical slot 79.

The perforated lines 80 divide the paddle into individual sections. Each section may have the same surface area, or they may vary. Because the paddle responds to air pressure in an amount dependent to its surface area, snapping off a segment with a set surface area will produce a known change in value to the amount of airflow the airflow monitoring switch 42 responds to as a result. This allows a user to effectively tune the airflow monitoring switch to a particular desired range. The smaller the paddle 48 becomes, the less likely it will be to respond to only a small change in airflow because it will not have enough surface area. A user can snap off the segments by simply bending the segments back and forth about the perforated lines 80 to weaken and break the connections between the perforations. A user adjusts the paddle to as close to the desired airflow as they can, and then make smaller, for finely tuned adjustments with the switch arm 46 to fully tune the system. Typically, the airflow monitoring switch 42 should be able to detect a change in airflow corresponding to the change in airflow caused by the activation of a single vacuum within the overall vacuum system. It will be tuned to avoid reacting to smaller changes, otherwise it may also detect a leak in the system as a vacuum stall being used. Because the surface areas of the individual sections may be different, a user can snap off a section that best fits the change in the detection of airflow that they need. If breaking off a larger section reduces the sensitivity too much, the user may instead break off a smaller section instead.

The airflow monitoring switch 42 of the present disclosure preferably can detect an airflow as low as about 50 cubic feet of air per second (cfm). Generally, the switch should be able to detect up to about 400 cfm to about 450 cfm. Additionally, the switch is able to survive, without breaking or becoming misshapen, up to an airflow of about 5000 cfm. If the airflow becomes too much, a “breakaway” mechanism engages to protect the paddle 48 from becoming damaged. The airflow monitoring switch may also be adjusted up to a certain amount. The tension acting on the switch may be changed by the user, which allows the switch to only respond to predetermined pressure changes. A user can do small, “fine tuning” changes to the measuring capabilities with the tension adjustments. Major adjustments are made by breaking off sections of the paddle 48 instead. The airflow monitoring switch can be deflected to a distance of about 0.5 inches before it hits a stop and cannot move any further.

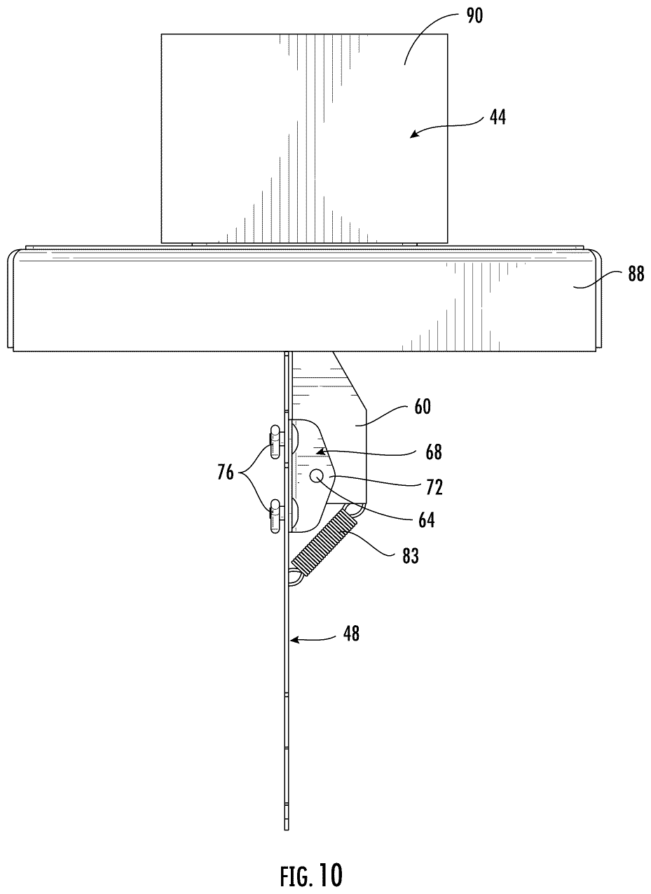

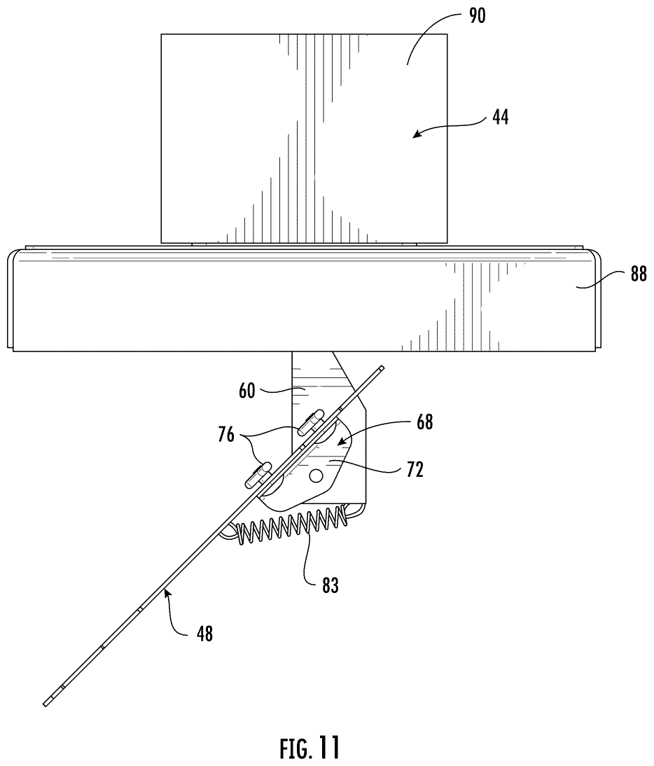

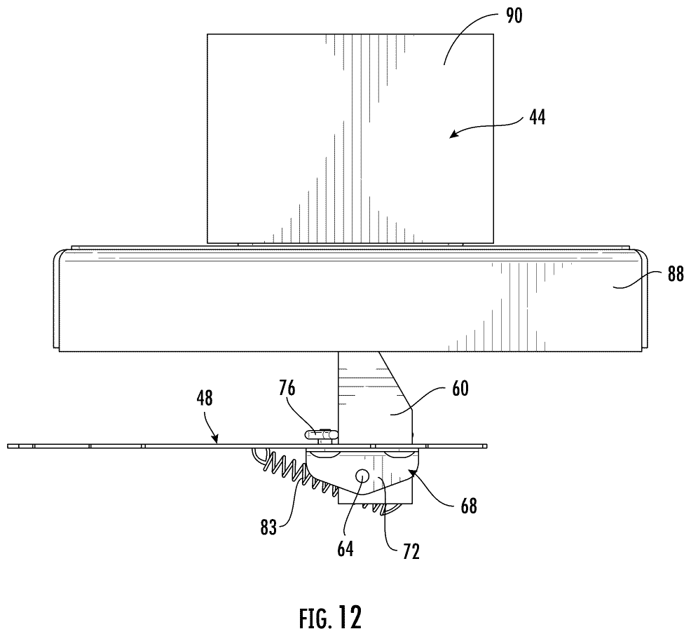

A spring 83, which is typically a coil spring, or other elastomeric force applying device is typically connected to the paddle and the paddle connection portion 54, although it is separate from the hinge that operably connects the two. One end of the spring is attached to the angled connection portion proximate to a corner between the first straight edge and the second straight edge. The opposite end of the spring is attached to the paddle 48 proximate to the center point of the paddle. The spring 83 creates a restoring force to maintain the paddle in its original position relative to the switch arm 46. The rest position of the paddle is shown in FIG. 10. If the paddle rotates clockwise, or with its bottom portion directed towards the airflow, the spring 83 is stretched. If the paddle rotates counterclockwise, or with its bottom directed against the direction of airflow, the spring contracts. Typically, the paddle will rotate clockwise with the airflow as shown in FIG. 11 and FIG. 12. When the airflow is too strong and overpowers the spring's restoring force, the paddle 48 will be forced into an upwards position, or clockwise rotation, as shown in FIGS. 11 and 12. This enables the air to pass by it easily and reduces the strain put on the paddle by the passing air. This prevents damage to the paddle and increases the durability of the switch. When the airflow is reduced to a safe level, and does not overpower the spring's restoring force, the spring pulls the paddle 48 back into position. FIG. 12 shows the paddle in its breakaway position.

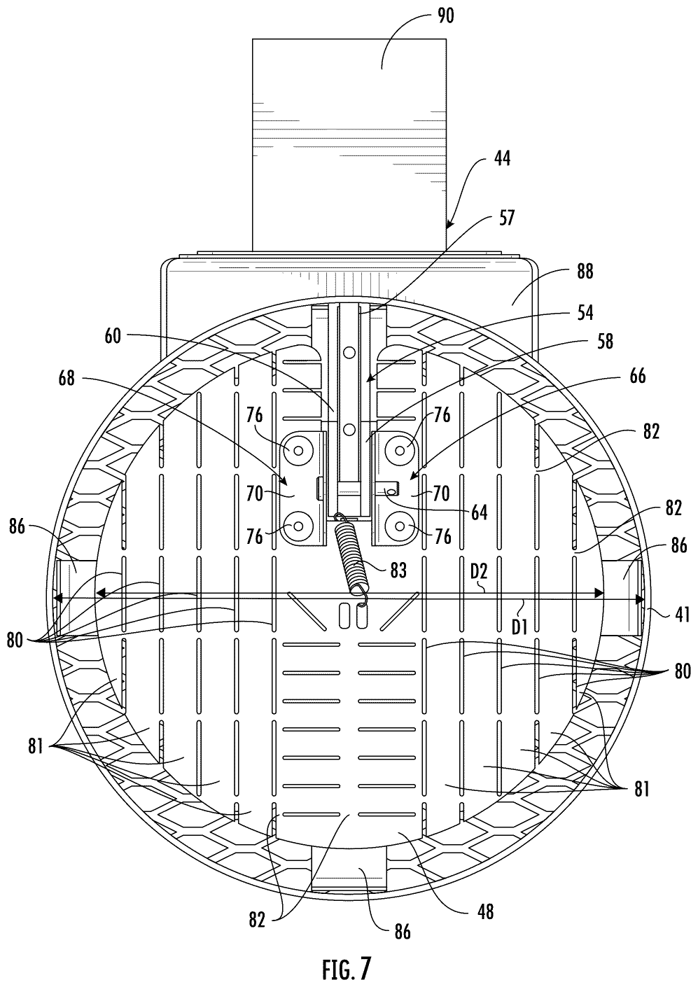

As shown in FIGS. 7-8 and 13, the filter 50 of the present disclosure typically includes a circular mesh having a plurality of openings to allow air to pass through. The filter prevents debris from making it all of the way through the main vacuum line to the vacuum motor. In particular, the filter prevents loose pieces from the airflow monitoring switch from falling into the vacuum motor if they happen to break off. Because of the perforated lines 80, the paddle has a number of weak points along its surface that could break if the airflow grows too strong or if another piece of debris or a broken vacuum component were to strike it. The weak points 82 connect the segments 81 together and are located in between the perforations of the perforated lines 80. They are significantly smaller than the perforations, meaning they will easily bend or break when a small amount of force is applied to them. In general, only a human hand or finger force is necessary to break the weak points 82 and they may be broken by hand and without the use of tools. By blocking broken mechanical components at the filter, the operational lifetime of the vacuum motor is increased as it will be less likely to break.

The filter typically is made of a metal, such as aluminum, iron, or steel. It may be a solid unitary piece with holes cut or punched out of it, or it may be a wire mesh formed with multiple interconnecting wires. In some embodiments, the filter is at least partially flexible. The diameter of the filter is the same or substantially the same as the diameter of the inside of main vacuum line (D1). The diameter of the filter is typically from about 7.5 inches to about 8.5 inches, or most typically around 8 inches, in order to conform to the standard vacuum line diameter. In this way, debris cannot slip through between the filter and the inside surface of the main vacuum line. The filter is secured to the inside surface of the main vacuum line by a plurality of L-shaped brackets 86 space at regular intervals around the perimeter of the filter. The L-shaped brackets 86 are secured to the filter and to the main vacuum line via welding. The connection between the brackets and the main vacuum line should be secure enough that the filter does not move or break if it is struck with debris or broken/loose mechanical parts that may be sucked into the main vacuum line.

The sensor portion 44 includes a vacuum line engaging base 88, an upper compartment 90, and a pressure detecting switch 42 that the switch arm is a part of. Typically, a hole/aperture will be cut out from the top of the main vacuum line so that the sensor portion can be fit over top and the switch arm 46 can reach into the main vacuum line. The vacuum line typically engages a form fitting lip 94 on the underside of the vacuum line engaging base 88. The form fitting lip creates an air tight fit so that air cannot escape and disrupt the airflow. The form fitting lip 94 may be welded to the vacuum line portion 41. In alternative aspects of the present disclosure, the sensor portion is a separate piece that can removed by a user so that it can easily be repaired or replaced and the connection is made by removable fasteners. The fasteners may be adjusted and removed by hand and without the use of tools. A gasket may be included between the form fitting lip and the main vacuum line so that the seal is air tight. The form fitting lip has two straight edges that follow the direction of the main vacuum line, and two arcuate edges that match the curve of the main vacuum line. Opposite to the form fitting lip is an upper portion of the vacuum line engaging base. On top of the upper portion is the upper compartment 90. As shown in FIG. 6, the pressure detecting switch 42, which is typically an electrical switch, is held within the upper compartment, and the switch arm is enabled to pass through the upper portion and into the vacuum line portion below. The pressure detecting switch is in signal communication with the vacuum motor, or vacuum motors, so that the vacuum motor can adjust its power or suction provided over feedback from the sensor portion. The communication may be a wired signal connection, or a wireless signal connection such as over WIFI®, a Local area Network (LAN), internet connection, an internet of things (IOT) connection, a cellular connection, or other another wireless signal communication(s). A vacuum controller may be included with the vacuum motor that controls the vacuum motor and communicates with the pressure detecting switch. The vacuum controller may be in signal communication with an external computing device. The pressure detecting switch may also be in signal communication with an external computing device, such as a user operated cellular/mobile phone or a user operated computer system located remote from the switch. The pressure detecting switch may be able to alert the user if the airflow reaches a certain threshold, such as the airflow required to trigger the breakaway mechanism. An extreme change in airflow may indicate that something is wrong with the system, such as a broken component or a clog along the main vacuum line. An appropriate notification of such a condition may be provided to one or more authorized users of the system.

During the operation of an overall vehicle treatment facility, the vacuum motor or motors runs continuously throughout the day or during business hours. The airflow monitoring switch system continuously monitors the airflow traveling through the main vacuum lie to the vacuum motor. During times of low vacuum use, the vacuum system enters a “sleep mode”, or low power mode, wherein the suction is decreased. The sleep mode allows the vacuum system to use less energy and produce a cost savings for the overall vehicle treatment facility. Because the motor is always running, it does not need to turn off and on again, which makes it quicker to use for a customer and won't put as much strain on the motor as it switches between being stationery and moving/activated conditions of use. Additionally, with air always moving, it is less likely for clods of ice, snow, dirt and other debris to settle in the vacuum lines. When a customer of the overall vehicle treatment facility goes to vacuum their vehicle and activates the vacuum at the vacuum stall, the airflow within the main vacuum line will change. The change may be very small and difficult to measure for other sensor systems, but would be typically detected by the systems of the present disclosure.

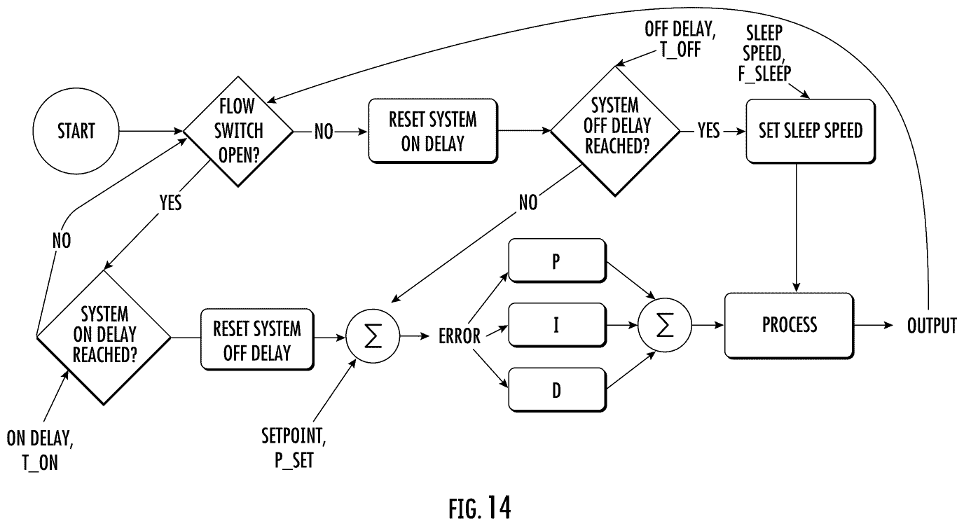

A diagram showing the logic of the airflow monitoring switch system is shown in FIG. 14. The airflow monitoring switch system makes use of a proportional-integral-derivative (PID) controller to check the pressure detected by the pressure detecting switch, determine the required airflow, and send a signal to the vacuum motor to change to the required airflow. The sequence occurs on a loop. The airflow monitoring switch system repeatedly checks the airflow within the main vacuum line and responds accordingly. Additionally, whenever airflow monitoring switch changes the vacuum motor changes the airflow, it is done on a delay. The delay is typically 20 seconds, although it may be longer or shorter depending on the needs of the overall vehicle treatment facility or the quality or type of vacuum motor. The delay ensures that the vacuum motor is not repeatedly switching between a low power and high power or between on and off. A user may activate and reactivate a vacuum hose all within a small amount of time.

At the start of every loop, the system checks to see it the switch is in an “open” or “activated” state. The activated state is determined in comparison to the most recent airflow speed. As an example, if the airflow is at its maximum airflow sue to a vacuum being in operation, then the activated state corresponds to the position of the switch under maximum airflow and the deactivated state corresponds to the switch in a position slightly below the maximum airflow. If the airflow is at an amount below maximum and corresponding to a number of vacuums being unused, then the activated state corresponds to a slightly higher amount of airflow indicating another vacuum is being used or the same airflow while the current vacuums are in use, and the deactivated state corresponds to an amount of airflow that is lower than the most recent airflow. Following the path shown in FIG. 14, if the flow switch is open when the loop starts, then the system needs to determine if the delay before the system turns on has been reached. If not, the system continues to check if the switch is open and if the delay has been reached. This way, it won't just turn on after the delay if the switch has been turned off before the delay ends. If the delay has been reached, it proceeds in the process and resets the delay of time for the system to turn off. The delay is set back to 0 and counts up until the 20 seconds have elapsed. The PID controller than adjusts the power of the motor, and the system reverts back to checking if the flow switch is on. If at the start of the loop the flow switch is not on, then the delay before the system turns on is reset to 0 and counts up until 20 seconds is reached. If the switch is not activated, indicating that the vacuum is not in use, the airflow needs to be adjusted to the low power, or sleep mode, if it is not there already. If the system is currently in an active mode, which provides the necessary airflow for operating the vacuums, the system will switch to sleep mode. This change is done on delay, so that the vacuum motor is not repeatedly turning on and off again. The delay is typically about 20 seconds. Once the delay is over, the sleep mode is set and the airflow decreases to sleep mode levels. Before the delay is over, the PID controller continues to repeatedly check the airflow monitoring switch to see if the pressure detecting switch is showing a pressure corresponding to the sleep mode airflow and if the delay is over. If the switch is activated before the delay is over, the delay is reset and the active mode of the airflow is engaged.

If the switch is activated when the PID controller performs a check, the PID controller instead first checks if it switching to sleep mode but currently in the time period for the delay. If the delay is not over, then the airflow monitoring switch system continues to monitor the whether the pressure detecting switch is active. If the delay is over, and the switch is still active, this indicates that a customer is still using the vacuum and it should not be switched to sleep mode. The PID controller instead resets the delay and once again continues to monitor if the pressure detecting switch 42 is active. Once it detects the switch becoming inactive, then the PID controller can wait out the delay and change the airflow to sleep mode.

What is claimed is:

1. An airflow monitoring switch system that may be retrofitted into a vacuum line of a vehicle treatment facility and that monitors an airflow within the vacuum line, the airflow monitoring switch system comprising:
a vacuum line segment having a first open end, a second open end, and an upper opening located between the first open end and the second open end, and wherein the vacuum line segment replaces a portion of the vacuum line;
a switch at least partially positioned above the opening located between the first open end and the second open end and wherein the switch comprises a switch arm that passes through the upper opening into an interior of the vacuum line segment;
a paddle hingedly connected to the switch arm, wherein the paddle has a first surface and a second surface opposite to the first surface and the paddle is planar and the paddle is sized to have the same shape as an interior shape of the vacuum line segment that is defined by an interior surface of the vacuum line segment and wherein the paddle fills at least about 80% of the airflow through the vacuum line segment when the paddle is in a rest position defined as a position where the first surface and the second surface are aligned with the switch arm, and wherein the paddle has a rotated position wherein the first surface and the second surface form a non-zero degree angle with the switch arm; and
wherein the first surface and the second surface of the paddle are perpendicular to a direction of airflow within the vacuum line.

2. The airflow monitoring switch system of claim 1, wherein the paddle is circular and further comprises a vertical slot running from an uppermost point of the paddle and downwards towards a center point of the paddle, and wherein the switch arm is proximate to the vertical slot such that when the paddle is in the rotated position the switch arm is at least partially within the vertical slot.

3. The airflow monitoring switch system of claim 2, wherein the paddle further comprises a first paddle connection portion and a second paddle connection portion that are engaged to the paddle on either side of the vertical slot and wherein the first paddle connection portion and a second paddle connection portion are both hingedly engaged to the switch arm.

4. The airflow monitoring switch system of claim 3, wherein the paddle is biased towards the rest position by a spring or an elastomer having an ability to stretch and deform under pressure or application of a force and then return to its original shape and remains in the rest position unless acted on by an external force.

5. The airflow monitoring switch system of claim 4, wherein the paddle has a width greater than its height and further comprises at least one perforated line that divides the paddle into segments that are connected to each other through areas of reduced width as compared a width of a perforation within the at least one perforated line and wherein is the paddle is biased by a coil spring having a first end attached to the switch arm and a second end that is attached to the paddle.

6. The airflow monitoring switch system of claim 5, wherein the segments have an identical surface area and wherein the vacuum line segment is free of any use of airflow directing wings affixed to an internal surface of the vacuum line segment.

7. The airflow monitoring switch system of claim 1 further comprising a PID controller in signal communication with the switch and a vacuum motor of the vehicle treatment facility.

8. The airflow monitoring switch system of claim 1, wherein the paddle further has a breakaway position, wherein the first surface and the second surface of the paddle are both aligned with an airflow direction.

9. The airflow monitoring switch system of claim 1 further comprising a filter positioned inside the vacuum line segment and downstream in an airflow direction from the paddle.

10. The airflow monitoring switch system of claim 1, wherein the vehicle treatment facility further comprises a debris separator that is engaged to a first end of the vacuum line and a vacuum motor that is engaged with a second end of the vacuum line, and wherein the airflow monitoring switch system is disposed between the first end of the vacuum line and the second end of the vacuum line.

11. An airflow monitoring switch system comprising:
a switch having a switch arm that passes through an upper opening of a vacuum line wherein at least a portion of the switch arm extends through the upper opening of the vacuum line and into an interior of the vacuum line;
a paddle having a first surface, a second surface opposite to the first surface, and a vertical slot running from an uppermost point of the paddle and downwards towards a center point of the paddle;
a first paddle engaging bracket hingedly engaged to the switch arm and the paddle and a second paddle engaging bracket hingedly engaged to the switch arm on an opposite side of the first paddle engaging bracket and wherein the paddle swings relative to the switch arm in response to a force and has a rest position where the first surface and the second surface are aligned with the switch arm and a rotated position where the first surface and the second surface form a non-zero degree angle with the switch arm;
wherein the vertical slot has a width that is greater than a width of the switch arm and that when the paddle is in the rotated position the switch arm is at least partially within the vertical slot; and
wherein the paddle is suspended within the vacuum line.

12. The airflow monitoring switch system of claim 11, wherein the paddle further comprises at least one perforated line that divides the paddle into segments that are connected to each other through areas of reduced width as compared a width of a perforation within the at least one perforated line.

13. The airflow monitoring switch system of claim 11 further comprising a PID controller in signal communication with the switch and a vacuum motor of a vehicle treatment facility and wherein the vacuum line is free of any use of airflow directing wings affixed to an internal surface of the vacuum line proximate the switch.

14. The airflow monitoring switch system of claim 11,
wherein the airflow monitoring switch system further comprises a spring having a first end attached to the switch arm and a second end that is attached to the paddle; and
wherein the paddle is biased towards the rest position by the spring.

15. The airflow monitoring switch system of claim 12, wherein the segments have an identical surface area.

16. The airflow monitoring switch system of claim 11 further comprising a switch base portion that is engaged to an exterior of the vacuum line and completely covers the upper opening, and wherein the switch is operably engaged with the switch base portion; and
wherein the paddle fills at least about 80% of the airflow through the vacuum line when the paddle is in a rest position.

17. A method of adjusting an airflow within a main vacuum line that is part of a vehicle treatment facility having a vacuum motor and at least one vacuum stall and wherein the main vacuum line provides suction from the vacuum motor to a vacuum hose associated with at least one vacuum stall, the method using an airflow monitoring switch of claim 1 and comprising the steps of:
a user beginning to use the vacuum hose associated with the at least one vacuum stall thereby changing rate of airflow passing the airflow monitoring switch defining a change in the rate of airflow;
the change in the rate of airflow thereby activating the switch by increasing a pressure on the paddle of the switch due to the change in the rate of airflow, and wherein the switch is activated if the pressure on the paddle is at or greater than a predetermined pressure on the paddle;
sending a signal to the vacuum motor if the pressure on the paddle is at or greater than the predetermined pressure on the paddle;
increasing the airflow within the main vacuum line using the vacuum motor to set an operating airflow, wherein the operating airflow is greater than an initial airflow plus the change in airflow, and the operating airflow is at an amount of at least a required airflow sufficient to provide vacuum power to all users of the vehicle treatment facility;
deactivating use of the vacuum hose associated with the at least one vacuum stall thereby decreasing airflow within the main vacuum line so that a second new airflow that is lower than the operating airflow results;
deactivating the switch due to the second new airflow decreasing the pressure on the paddle to a level below a second predetermined pressure and wherein the switch will not deactivate if the pressure on the paddle is above the second predetermined pressure;
sending a signal to the vacuum motor once the switch is deactivated to decrease the airflow provided by the vacuum motor; and
decreasing the airflow within the main vacuum line provided by the vacuum motor.

18. The method of claim 17, wherein the paddle further comprises at least one perforated line that divides the paddle into segments that are connected to each other through areas of reduced width as compared a width of a perforation within the at least one perforated line.

19. The method of claim 18 further comprising a step of manually adjusting the predetermined amount of pressure that will cause the switch to trigger by breaking one or more areas of reduced width as compared a width of a perforation within the at least one perforated line, wherein the one or more areas of reduced width as compared a width of a perforation within the at least one perforated line is part of the segments and to one or more remaining segments adjacent to the segments on the paddle.

20. The method of claim 17, wherein the paddle has a breakaway position where the first surface and the second surface are parallel with a direction of the airflow within the main vacuum line.
